(19) United States
(12) Patent Application Publication
(10) Pub. No.: US 2022/0066769 A1
(43) Pub. Date: Mar. 3, 2022

(54) UNMANNED VEHICLE, UNMANNED VEHICLE SOFTWARE AND FIRMWARE UPDATING METHOD AND SYSTEM

(71) Applicant: Coretronic Corporation, Hsin-Chu (TW)

(72) Inventor: Ying-Kai Lo, Hsin-Chu (TW)

(73) Assignee: Coretronic Corporation, Hsin-Chu (TW)

(21) Appl. No.: 17/383,450

(22) Filed: Jul. 23, 2021

(30) Foreign Application Priority Data
Aug. 31, 2020 (CN) 202010892613.6

(51) Int. Cl. G06F 8/65; B64C 39/02; B64F 5/60; G05D 1/10; G06F 9/445; H04L 29/08

(52) U.S. Cl. CPC G06F 8/65; B64C 39/024; B64F 5/60; B64C 2201/00; G06F 9/445; H04L 67/06; G05D 1/101

(57) ABSTRACT

An unmanned vehicle, and an unmanned vehicle software and firmware updating system and method, are provided. The method includes the following steps. A geographical location of the unmanned vehicle is obtained. A specific field type corresponding to the geographical location is obtained. A software and a firmware of the unmanned vehicle are determined to be in need of updating. A new program version for updating the software and the firmware of the unmanned vehicle is obtained based on the specific field type. The software and the firmware of the unmanned vehicle are updated according to the new program version.

### CROSS-REFERENCE TO RELATED APPLICATION

This application claims the priority benefit of China application serial no. 202010892613.6, filed on Aug. 31, 2020. The entirety of the above-mentioned patent application is hereby incorporated by reference herein and made a part of this specification.

### BACKGROUND

### Technical Field

This disclosure relates to a technology for managing an unmanned vehicle, and in particular to an unmanned vehicle, and a method and a system for updating software and firmware of the unmanned vehicle.

### Description of Related Art

In recent years, unmanned vehicles have been widely applied and can be seen in many industries and fields such as environmental protection, disaster relief, transportation, security control, and agriculture. In addition, with the maturity of related technology, there are now even applications in which multiple unmanned vehicles work collaboratively to complete a task. For example, collaboration between drone fleets composed of multiple drones to perform tasks such as aerial patrols, thereby greatly improving efficiency during execution of official duties and enhancing effectiveness of security. In addition, there are already applications in the past in which the drone fleets are controlled to assist in disaster control such as conducting aerial surveys and collecting disaster data.

In order to realize the collaboration between unmanned vehicles fleets, functions in a system for managing an unmanned vehicle fleet such as remote control of the status of each unmanned vehicle and mission execution appear to be even more important. In addition, updating the unmanned vehicle fleet in an automated manner through the system for managing the unmanned vehicle fleet when software and firmware of the unmanned vehicle need to be updated can also reduce costs and enhance efficiency.

However, the existing practice of updating the unmanned vehicle has the following two issues mainly. Firstly, the software and the firmware of a general unmanned vehicle still need to be updated through the initiative of a user. However, for an unmanned vehicle fleet deployed to a remote area, it is difficult for the update program to be initiated through the user. Secondly, the unmanned vehicle is unable to perform a corresponding software update in response to a specific geographical location. For example, software and firmware parameters (such as artificial intelligence model parameters) required for an unmanned vehicle fleet configured to observe an ocean are different from that of an unmanned vehicle fleet configured to observe a forest, therefore requiring the unmanned vehicle fleets to be updated separately.

The information disclosed in this background section is only for enhancement of understanding of the background of the described technology, and therefore it may contain information that does not form the prior art that is already known to a person of ordinary skill in the art. Furthermore, the information disclosed in the background section does not mean that one or more problems to be resolved by one or more embodiments of the disclosure were acknowledged by a person of ordinary skill in the art.

### SUMMARY

This disclosure provides an unmanned vehicle, and an unmanned vehicle software and firmware updating method and system.

The disclosure provides an unmanned vehicle software and firmware updating method, which includes the following steps. A geographical location of the unmanned vehicle is obtained. A specific field type corresponding to the geographical location is obtained. The software and the firmware of the unmanned vehicle are determined to be in need of updating. A new program version for updating the software and the firmware of the unmanned vehicle is obtained based on the specific field type. The software and the firmware of the unmanned vehicle are updated according to the new program version.

The disclosure provides an unmanned vehicle, which includes a positioning circuit and a processor. The processor is coupled to the positioning circuit and is configured to perform the following steps. The positioning circuit is controlled to obtain a geographical location of the unmanned vehicle. A specific field type corresponding to the geographical location is obtained. The software and the firmware of the unmanned vehicle are determined to be in need of updating. A new program version for updating the software and the firmware of the unmanned vehicle is obtained based on the specific field type. The software and the firmware of the unmanned vehicle are updated according to the new program version.

The disclosure provides an unmanned vehicle software and firmware updating system, which includes an update server, an unmanned vehicle management system, and at least one of the unmanned vehicles. The update server is configured to release a new program version.

The unmanned vehicle management system sends a new program update command in response to the new program version released by the update server. Each of the unmanned vehicles includes a positioning circuit and a processor. The positioning circuit provides a geographical location. The processor is coupled to the positioning circuit and is configured to execute the following steps. The new program update command is received, and in response to the new program update command, the software and the firmware of the unmanned vehicle are determined to be in need of updating and the geographical location of the unmanned vehicle is obtained. A specific field type corresponding to the geographical location is obtained. The new program version for updating the software and the firmware of the unmanned vehicle is obtained from the update server based on the specific field type. The software and the firmware of the unmanned vehicle are updated according to the new program version.

The disclosure provides an unmanned vehicle software and firmware updating system, which includes an update server and at least one of the unmanned vehicles. The update server is configured to release a new program version. Each of the unmanned vehicles includes a positioning circuit and a processor. The positioning circuit provides a geographical location. The processor is coupled to the positioning circuit, and is configured to execute the following steps. The geographical location of the unmanned vehicle is obtained. A specific field type corresponding to the geographical location is obtained. A current specific field type of a program version of the software and the firmware of the unmanned vehicle is read. The software and the firmware of the unmanned vehicle are determined to be in need of updating in response to the current specific field type being different from the specific field type. The new program version for updating the software and the firmware of the unmanned vehicle is obtained from the update server based on the specific field type in response to the software and the firmware of the unmanned vehicle being in need of updating. The software and the firmware of the unmanned vehicle are updated according to the new program version.

Based on the above, the disclosure may allow the unmanned vehicle to obtain the applicable software and firmware version from the update server based on the geographical location by itself, and then performing the software and the firmware update by itself.

To make the above features and advantages more comprehensible, several embodiments accompanied by drawings are described in detail as follows.

Other objectives, features and advantages of the disclosure can be further understood from the further technological features disclosed by the embodiments of the disclosure in which there are shown and described as exemplary embodiments of the disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and together with the descriptions serve to explain the principles of the disclosure.

FIG. 1 is a schematic diagram of an unmanned vehicle software and firmware updating system according to an embodiment of the disclosure.

FIG. 2 is a flowchart of an unmanned vehicle software and firmware updating method according to an embodiment of the disclosure.

FIG. 3A is a schematic diagram of reporting an update result according to an embodiment of the disclosure.

FIG. 3B is another schematic diagram of reporting the update result shown in FIG. 3A.

FIG. 4 is a schematic diagram of an unmanned vehicle software and firmware updating system according to an embodiment of the disclosure.

### DESCRIPTION OF THE EMBODIMENTS

It is to be understood that other embodiment may be utilized and structural changes may be made without departing from the scope of the disclosure. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted”, and variations thereof herein are used broadly and encompass direct and indirect connections, couplings, and mountings.

In summary, the disclosure allows an unmanned vehicle to perform a corresponding software and firmware update in response to a specific field type to which its geographical location belongs to, so that a program version on the updated unmanned vehicle is able to match a required application category. In this way, the disclosure provides possible advantages such as automated management, self-adaptive updating, labor cost saving, and time cost saving.

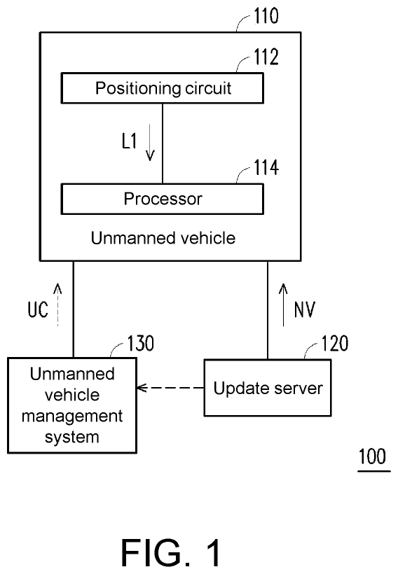

With reference to FIG. 1, FIG. 1 is a schematic diagram of an unmanned vehicle software and firmware updating system according to an embodiment of the disclosure. As shown in FIG. 1, an unmanned vehicle software and firmware updating system 100 includes an unmanned vehicle 110, an update server 120, and an unmanned vehicle management system 130.

In the embodiment, the unmanned vehicle 110 is, for example, a drone, or any other kind of unmanned transportation devices, but is not limited thereto. The unmanned vehicle 110 may include a positioning circuit 112 and a processor 114. The positioning circuit 112 is, for example, a global positioning system (GPS) module, which may be used to provide or obtain a geographical location of the unmanned vehicle 110, but the disclosure is not limited thereto. In some embodiments, the unmanned vehicle 110 may be docked at a base station (for example, for mission docking, charging or data exchange) in its work region regularly or irregularly. Therefore, the unmanned vehicle 110 may not have to carry the positioning circuit 112, and instead directly request the base station where it is docked to provide a geographical location of the base station, and use the geographical location of the base station as the geographical location of the unmanned vehicle 110, but the disclosure is not limited thereto.

The processor 114 of the unmanned vehicle 110 is coupled to the positioning circuit 112. The processor 114 may be a general-purpose processor, a special-purpose processor, a traditional processor, a digital signal processor, multiple microprocessors, one or more microprocessors combined with a digital signal processor core, a controller, a microcontroller, an application specific integrated circuit (ASIC), a field programmable gate array circuit (FPGA), any other type of integrated circuit, a state machine, an advanced RISC machine (ARM) processor or other similar devices.

In particular, the unmanned vehicle 110 may also optionally carry any kind of wired or wireless communication modules (not shown) configured for communication with the update server 120 and/or the unmanned vehicle management system 130.

Furthermore, the update server 120 of the unmanned vehicle software and firmware updating system 100 may be configured to store each of the software and firmware program versions corresponding to various field types. For example, the various field types include a forest, an ocean, a city, a road, a village, a mountain, etc. The update server 120 may then store each of the software and firmware program versions respectively corresponding to the above field types. In an embodiment, the update server 120 may also define the field types according to the different program versions (for example, same field but different old and new program versions). For example, assume that there are program versions such as “forest v1” and “forest v2”, then these program versions may be regarded as corresponding to the different field types, but the disclosure is not limited thereto.

The unmanned vehicle management system 130 of the unmanned vehicle software and firmware updating system 100 may be configured to manage one or more of the unmanned vehicles 110, and may control the managed unmanned vehicle 110 to perform a required software and firmware update. That is, the update server 120 may correspondingly release a new program version NV to the one or more of the unmanned vehicles 110. Specifically, the new program version NV is a software and firmware program version of one of the above field types. For example, in an embodiment, a relevant personnel uploads one or more of the new program versions NVs of the software and the firmware to the update server 120 (and the update server 120 releases the new program version NV). The unmanned vehicle management system 130 responds to the one or more of the new program versions NVs released by the update server 120 and may correspondingly generate a new program update command UC, before sending the new program update command UC to the unmanned vehicle 110. In this way, the unmanned vehicle 110 may initiate an update process, and the update server 120 may correspondingly upload the new program version NV to the one or more of the unmanned vehicles 110 to allow the unmanned vehicles 110 to perform the related software and firmware update accordingly.

In the embodiment of the disclosure, the processor 114 may be configured to load specific modules and/or program codes to implement a method for updating the software and the firmware of the unmanned vehicle proposed by the disclosure, which details are described in detail as follows.

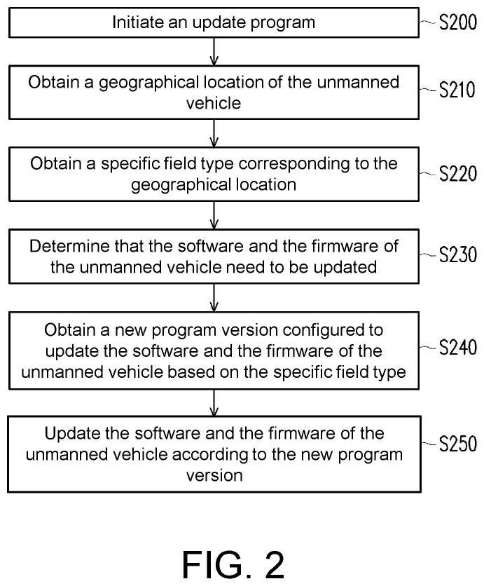

With reference to FIG. 2, FIG. 2 is a flowchart of an unmanned vehicle software and firmware updating method according to an embodiment of the disclosure. The unmanned vehicle software and firmware updating method of the embodiment may be executed by the unmanned vehicle 110 in FIG. 1. The details of each step in FIG. 2 are described as follows, in conjunction with the components shown in FIG. 1.

Firstly, in Step S200, the processor 114 initiates an update program. In an embodiment, the processor 114 performs the update program in response to the unmanned vehicle 110 receiving the new program update command UC from the unmanned vehicle management system 130. In another embodiment, after the update server 120 is loaded with the new program version NV (for example, upload by relevant personnel), the update server 120 may also send the new program update command UC to the unmanned vehicle 110 by itself to notify the unmanned vehicle 110 to perform the update program. In another embodiment, the processor 114 may update the program periodically or according to a schedule. In another embodiment, the processor 114 may initiate the update program when it approaches or is docked at the base station.

In Step S210, the processor 114 may obtain a geographical location L1 of the unmanned vehicle 110. In an embodiment, the processor 114 may control the positioning circuit 112 to obtain a GPS position as the geographical location L1 of the unmanned vehicle 110. In another embodiment, the processor 114 may also obtain a geographical location of the docked base station as the geographical location L1 of the unmanned vehicle 110, but the disclosure is not limited thereto. In particular, in the disclosure, the Step S200 and the Step S210 may be integrated, that is, the Step S200 may be omitted. For example, the processor 114 may initiate the update program once the geographical location L1 of the unmanned vehicle 110 is obtained. For example, the processor 114 may obtain (or update) the geographical location L1 regularly or according to a schedule, or the processor 114 may obtain (or update) the geographical location L1 when it approaches or is docked at the base station. In this way, the unmanned vehicle 110 may directly perform the update program after obtaining the geographical location L1, but the disclosure is not limited thereto.

In Step S220, the processor 114 may obtain a specific field type corresponding to the geographical location L1. In an embodiment, the unmanned vehicle 110 may store a map, and the map may be divided into multiple regions corresponding to the different field types, such as regions corresponding to a forest, an ocean, a city, a road, a village, or a mountain. In this case, after obtaining the geographical location L1, the processor 114 may determine in which of the above regions is the geographical location L1 located, and then infer the specific field type corresponding to the geographical location L1. For example, if the geographical location L1 is located in a region corresponding to a forest, the processor 114 may determine that the specific field type corresponding to the geographical location L1 is a forest. Another example is, if the geographical location L1 is located in a region corresponding to a city, the processor 114 may determine that the specific field type corresponding to the geographical location L1 is a city, but the disclosure is not limited thereto.

In another embodiment, the above map may also be stored in the update server 120. In this case, the processor 114 may also send the obtained geographical location L1 to the update server 120, so that the update server 120 may find out the specific field type corresponding to the geographical location L1. The update server 120 may find out the specific field type corresponding to the geographical location L1 in a manner similar to that described above, which will not be reiterated here.

After that, in Step S230, the processor 114 may determine that the software and the firmware of the unmanned vehicle 110 need to be updated.

In an embodiment, the processor 114 may read a current specific field type of a program version of the software and the firmware on the unmanned vehicle 110, and determine whether the current specific field type is the same as the specific field type corresponding to the geographical location L1. This means that the unmanned vehicle 110 may have moved from its original region to another region (for example, from a region corresponding to a forest to a region corresponding to a city) in response to the current specific field type being different from the specific field type. In this case, the processor 114 may determine that the software and the firmware of the unmanned vehicle need to be updated. In this way, the new program version NV obtained by the unmanned vehicle 110 according to the specific field type may be matched to the current region. It should be understood that the new program version NV in the embodiment may not necessarily be a program version newly uploaded to the update server 120 by the relevant personnel, it may only be a program version corresponding to another region instead. That is, the unmanned vehicle 110 may obtain the new program version NV suitable for the current geographical location in response only to a change in the geographical location. In particular, if the field type corresponding to the new program version NV is the same as the current field type on the unmanned vehicle 110, it may be determined that the software and the firmware of the unmanned vehicle 110 do not need to be updated, but the disclosure is not limited thereto.

After that, in Step S240, the processor 114 may obtain the new program version configured to update the software and the firmware of the unmanned vehicle 110 based on the specific field type. In an embodiment, the processor 114 may download the new program version NV corresponding to the specific field type from the update server 120. For example, if the specific field type corresponding to the geographical location L1 is a forest, the processor 114 may correspondingly obtain the new program version NV corresponding to the forest from the update server 120. In another example, if the specific field type corresponding to the geographical location L1 is an ocean, the processor 114 may correspondingly obtain the new program version NV corresponding to the ocean from the update server 120. In different embodiments, the new program version NV may include software and firmware parameters (for example, artificial intelligence model parameters) suitable for the above specific field type.

Then, in Step S250, the processor 114 may update the software and the firmware of the unmanned vehicle 110 according to the new program version NV.

It can be seen from the above description that in an embodiment, the unmanned vehicle management system 130 may correspondingly send the new program update command UC after the update server 120 is loaded with the new program version NV. After that, the unmanned vehicle 110 may receive the new program update command UC to initiate the update program and determined that the software and the firmware of the unmanned vehicle 110 need to be updated after the geographical location L1 of the unmanned vehicle 110 is obtained. Furthermore, the unmanned vehicle 110 may be configured to complete the following steps. The specific field type corresponding to the geographical location L1 is obtained. The new program version NV configured to update the software and the firmware of the unmanned vehicle 110 is obtained from the update server 120 based on the specific field type. The software and the firmware of the unmanned vehicle 110 are updated according to the new program version NV. Reference may be made to the description of the previous embodiment for the details of the above technical content, which will not be reiterated here. In particular, the above Steps S210 to S250 are not meant to limit the sequence of the steps during execution, and the disclosure is not limited thereto.

In addition, it can be seen from the above description that in another embodiment, the unmanned vehicle software and firmware updating system 100 may be adjusted to include only the update server 120 and the unmanned vehicle 110. In this case, the update server 120 may be configured to provide the new program version NV. Correspondingly, the unmanned vehicle 110 may be configured to complete the following steps. The geographical location of the unmanned vehicle 110 is obtained. The specific field type corresponding to the geographical location is obtained. The current specific field type of the program version of the software and the firmware on the unmanned vehicle 110 is read. The software and the firmware of the unmanned vehicle 110 are determined to be in need of updating in response to the current specific field type being different from the specific field type. The new program version NV configured to update the software and the firmware of the unmanned vehicle 110 is obtained from the update server 120 based on the specific field type, in response to the software and the firmware of the unmanned vehicle 110 being in need of updating. The software and the firmware of the unmanned vehicle 110 are updated according to the new program version NV. Reference may be made to the description of the previous embodiment for the details of the above technical content, which will not be reiterated here.

In an embodiment, since the software and the firmware update operation of the unmanned vehicle 110 may involve a reboot program, the processor 114 may control the unmanned vehicle 110 to execute a landing operation before specifically updating the software and the firmware of the unmanned vehicle 110. In this way, it can ensure that the software and firmware update operation is performed when the unmanned vehicle 114 is in a docked status, so as to prevent the unmanned vehicle 114 from crashing due to execution of the reboot program in a flight status.

In an embodiment, relevant management personnel may need to refer to related error or failure information to facilitate grasping of a functional situation of the unmanned vehicle 110 and perform subsequent maintenance when situations such as an error or a failure occur during a functioning of the unmanned vehicle 110. In this case, if the unmanned vehicle 110 rashly performs the software and firmware update, the above error or failure information may be lost.

Therefore, in some embodiments, before performing any of the Steps S200 to S250 (for example, before performing the Step S230 or the Step S250), the processor 114 may first determine whether a health status of the unmanned vehicle 110 is suitable for updating. For example, the processor 114 may first obtain an error code of the unmanned vehicle 110, and determine whether the error code indicates that the unmanned vehicle 110 has an error. In general, if the error code is 0, it means that the unmanned vehicle 110 has no error. On the other hand, if the error code is a code other than 0, it means that an error has occurred in the unmanned vehicle 110 (such as a memory error, a propeller damage, a battery damage, etc.), but the disclosure is not limited thereto.

Therefore, the processor 114 may determine that the health status of the unmanned vehicle 110 is suitable for updating in response to the error code not indicating that the unmanned vehicle 110 has an error. Correspondingly, the processor 114 may update the software and the firmware of the unmanned vehicle 110 according to the new program version NV.

Conversely, in response to the error code indicating that the unmanned vehicle 110 has an error, the processor 114 may determine that the health status of the unmanned vehicle 110 is unsuitable for updating. In this case, the processor 114 does not have to update the software and the firmware of the unmanned vehicle 110, but the disclosure is not limited thereto.

In other embodiments, the processor 114 may also determine whether the unmanned vehicle 110 is suitable for updating based on whether the unmanned vehicle 110 is in the flight status or whether the power of the battery is sufficient to support the entire update operation. For example, if the unmanned vehicle 110 is in the flight status and/or the power level of the battery is too low, the processor 114 may determine that the unmanned vehicle 110 is unsuitable for updating, but is not limited thereto.

It can be seen from the above that the disclosure allows the unmanned vehicle to obtain the suitable software and firmware version from the update server by itself based on the geographical location, and then update the software and the firmware by itself. In this way, the disclosure may at least have the following advantages. Firstly, the management is automated. Not only is human intervention not required in the entire process of updating the unmanned vehicle, updating to a wrong program version due to human negligence is also avoided. Secondly, the update is self-adaptive. Regardless of the field type corresponding to the region which the unmanned vehicle is deployed to, the unmanned vehicle can be updated to the software and the firmware suitable for the terrain and ground objects it faces according to its geographical location. Thirdly, labor cost is saved. Regardless whether the region that the unmanned vehicle is being deployed to is nearby or remote, the unmanned vehicle can perform automatic updates remotely, therefore there is no need to send a large amount of manpower to the deployment locations of the unmanned vehicles to update the software and the firmware. Lastly, time and cost are saved. As the unmanned vehicle can perform automatic updates remotely, the relevant personnel does not need to spend time getting to the place where the unmanned vehicle is being deployed, which can speed up deployment of the software and the firmware.

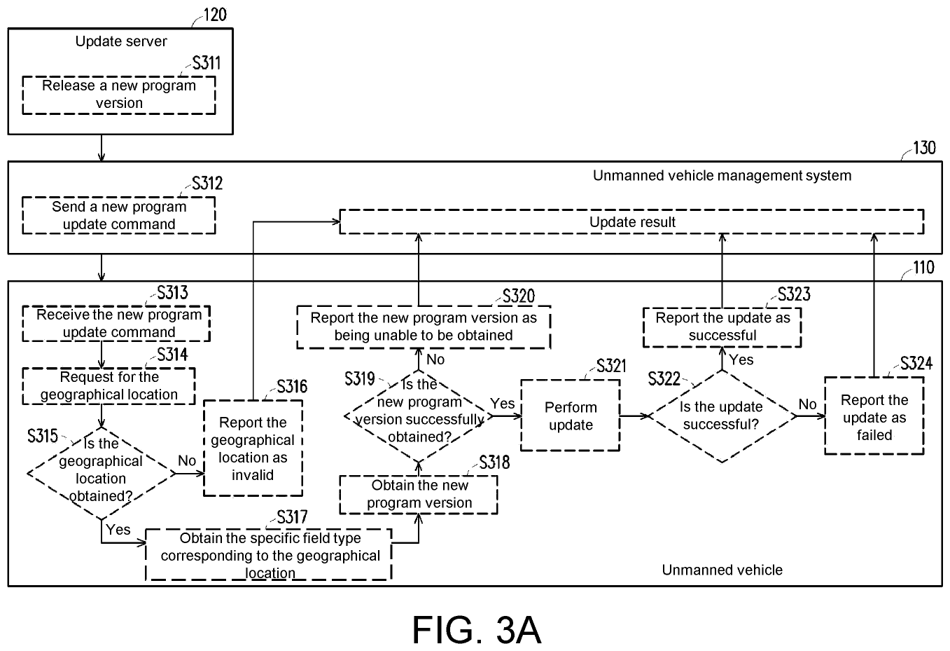

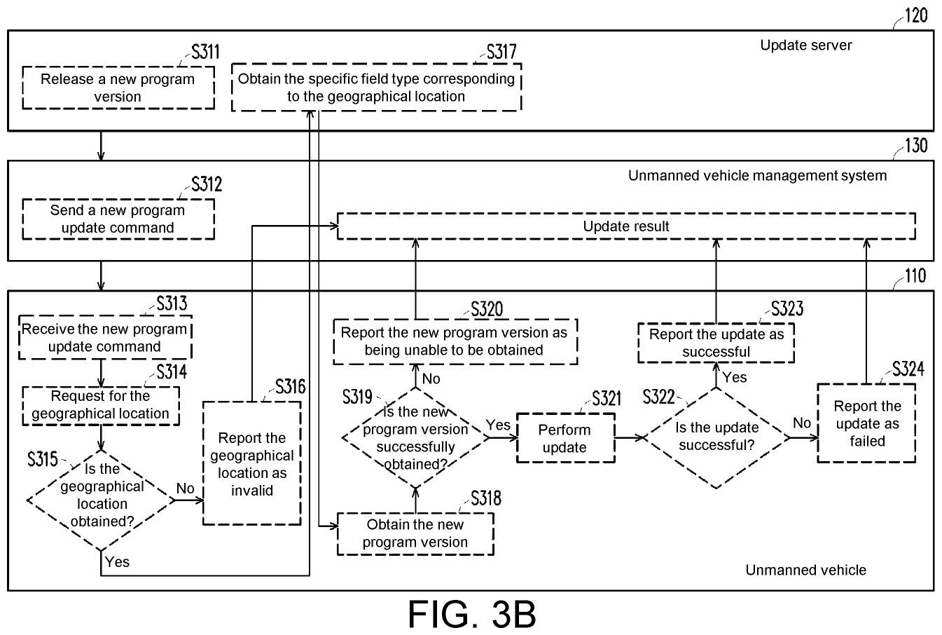

In an embodiment, the unmanned vehicle 110 may also report related update results to the unmanned vehicle management system 130 when appropriate. In different embodiments, the above update result may be configured to indicate results such as the geographical location is invalid, the new program version is unable to be obtained, the update has failed, or the update is successful. In order to make the above concept clearer, FIGS. 3A and 3B are supplemented in the following as further explanation.

With reference to FIG. 3A, FIG. 3A is a schematic diagram of reporting an update result according to an embodiment of the disclosure. Firstly, in Step S311, the update server 120 may release the new program version. In Step S312, the unmanned vehicle management system 130 may correspondingly send the new program update command to the unmanned vehicle 110.

In Step S313, the unmanned vehicle 110 may receive the new program update command, and request the positioning circuit 112 for the geographical location of the unmanned vehicle 110 in Step S314. After that, in Step S315, the unmanned vehicle 110 may determine whether the geographical location is obtained. If not, the unmanned vehicle 110 may continue to execute Step S316 to report “invalid geographical location” as the update result to the unmanned vehicle management system 130. On the other hand, if the geographical location is successfully obtained in the Step S315, the unmanned vehicle 110 may continue to execute Step S317 to obtain the specific field type corresponding to the geographical location, and obtain the corresponding new program version in Step S318.

After that, in Step S319, the unmanned vehicle 110 may determine whether the new program version is successfully obtained. If not (for example, there is an error in the downloading process), the unmanned vehicle 110 may execute Step S320 to report “unable to obtain the new program version” as the update result to the unmanned vehicle management system 130. On the other hand, if the new program version is successfully obtained in the Step S319, the unmanned vehicle 110 may execute Step S321 to update the software and the firmware.

Then, in Step S322, the unmanned vehicle 110 may determine whether the software and the firmware are successfully updated. If yes, the unmanned vehicle 110 may execute Step S323 to report “update is successful” as the update result to the unmanned vehicle management system 130. Otherwise, Step S324 is executed to report “update has failed” as the update result to the unmanned vehicle management system 130.

With reference to FIG. 3B, FIG. 3B is another schematic diagram of reporting the update result shown in FIG. 3A. In FIG. 3B, reference may be roughly made to the related description in FIG. 3A for the content of each of the steps. However, in FIG. 3B, the Step S317 is executed by the update server 120 to obtain the specific field type corresponding to the geographical location of the unmanned vehicle 110.

It can be seen from the above that the disclosure may also report the corresponding update result according to the change in the update process of the unmanned vehicle 110, so that the unmanned vehicle management system 130 may more accurately grasp the related information.

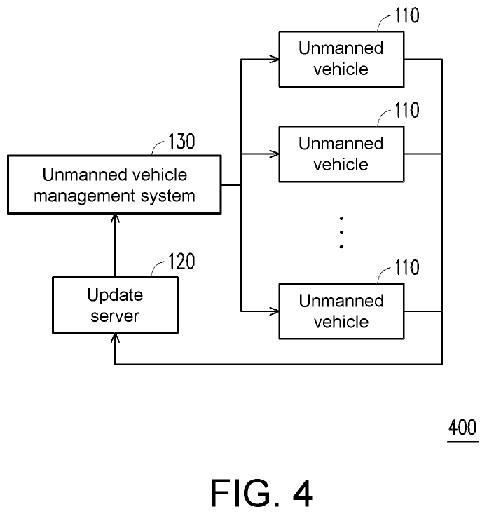

With reference to FIG. 4, FIG. 4 is a schematic diagram of an unmanned vehicle software and firmware updating system according to an embodiment of the disclosure. In the embodiment, an unmanned vehicle software and firmware updating system 400 may include the multiple unmanned vehicles 110, the update server 120, and the unmanned vehicle management system 130. In the embodiment, each of the unmanned vehicles 110 may perform its own software and firmware update operation according to the method described in the above embodiments, and reference may be made to the description of the previous embodiments for the related details, which will not be reiterated here.

In summary, the disclosure may find out the corresponding specific field type according to the geographical location of the unmanned vehicle after obtaining the geographical location of the unmanned vehicle. Accordingly, the unmanned vehicle may obtain the applicable software and firmware version from the update server by itself for updating. In this way, the program version on the updated unmanned vehicle may be matched to the required application category, thereby having advantages such as automated management, self-adaptive update, saved labor costs, and saved time and cost.

However, the above are only exemplary embodiments of the disclosure, and should not be used to limit the scope of the implementations of the disclosure. That is, all simple equivalent changes and modifications made in accordance with the claims and content of the disclosure are still within the scope of the disclosure. In addition, any embodiment or claim of the disclosure does not have to achieve all the objectives or advantages or features disclosed in the disclosure. Furthermore, the abstract and the title of the disclosure are only provided to assist in the retrieval of patent documents, and not to limit the scope of the disclosure.

The foregoing description of the exemplary embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby enabling persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the terms “the disclosure”, “the present disclosure” or the like does not necessarily limit the claim scope to a specific embodiment, and the reference to particularly exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given.

The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims.

Any advantages and benefits described may not apply to all embodiments of the disclosure. It should be appreciated that variations may be made in the embodiments described by persons skilled in the art without departing from the scope of the disclosure as defined by the following claims. Moreover, no element and component in the disclosure is intended to be dedicated to the public regardless of whether the element or component is explicitly recited in the following claims.

What is claimed is:

1. An unmanned vehicle software and firmware updating method, comprising:
obtaining a geographical location of an unmanned vehicle;
obtaining a specific field type corresponding to the geographical location;
determining that a software and a firmware of the unmanned vehicle need to be updated;
obtaining a new program version for updating the software and the firmware of the unmanned vehicle based on the specific field type; and
updating the software and the firmware of the unmanned vehicle according to the new program version.

2. The unmanned vehicle software and firmware updating method according to claim 1, wherein the step of determining that the software and the firmware of the unmanned vehicle need to be updated comprises:
reading a current specific field type of a program version of the software and the firmware of the unmanned vehicle; and
determining that the software and the firmware of the unmanned vehicle need to be updated in response to the current specific field type being different from the specific field type.

3. The unmanned vehicle software and firmware updating method according to claim 1, further comprising:
initiating an update program, comprising:
performing the update program by the unmanned vehicle in response to the unmanned vehicle receiving a new program update command.

4. The unmanned vehicle software and firmware updating method according to claim 3, further comprising:
reporting an update result by the unmanned vehicle to an unmanned vehicle management system.

5. The unmanned vehicle software and firmware updating method according to claim 3, further comprising:
generating the new program update command by an unmanned vehicle management system in response to the new program version released by an update server.

6. The unmanned vehicle software and firmware updating method according to claim 1, wherein the step of obtaining the specific field type corresponding to the geographical location comprises:
providing the geographical location of the unmanned vehicle to an update server, to allow the update server to find out the specific field type corresponding to the geographical location.

7. The unmanned vehicle software and firmware updating method according to claim 1, wherein the step of obtaining the new program version for updating the software and the firmware of the unmanned vehicle based on the specific field type comprises:
downloading the new program version corresponding to the specific field type from an update server.

8. The unmanned vehicle software and firmware updating method according to claim 1, wherein the specific field type comprises at least one of a forest, an ocean, a city, a road, a village, and a mountain.

9. The unmanned vehicle software and firmware updating method according to claim 1, before the step of updating the software and the firmware of the unmanned vehicle according to the new program version, the method for updating the software and the firmware of the unmanned vehicle further comprising:
determining whether a health status of the unmanned vehicle is suitable for updating;
updating the software and the firmware of the unmanned vehicle according to the new program version in response to the health status of the unmanned vehicle being determined to be suitable for updating; and
not updating the software and the firmware of the unmanned vehicle in response to the health status of the unmanned vehicle being determined to be unsuitable for updating.

10. The unmanned vehicle software and firmware updating method according to claim 9, wherein the step of determining whether the health status of the unmanned vehicle is suitable for updating comprises:
obtaining an error code of the unmanned vehicle and determining whether the error code indicates that the unmanned vehicle has an error;
determining the health status of the unmanned vehicle to be suitable for updating in response to the error code not indicating that the unmanned vehicle has an error; and
determining the health status of the unmanned vehicle to be unsuitable for updating in response to the error code indicating that the unmanned vehicle has an error.

11. The unmanned vehicle software and firmware updating method according to claim 1, before the step of updating the software and the firmware of the unmanned vehicle according to the new program version, the method for updating the software and the firmware of the unmanned vehicle further comprising controlling the unmanned vehicle to execute a landing operation.

12. An unmanned vehicle, comprising a positioning circuit and a processor, wherein the processor is coupled to the positioning circuit and is configured to:
control the positioning circuit to obtain a geographical location of the unmanned vehicle;
obtain a specific field type corresponding to the geographical location;
determine that a software and a firmware of the unmanned vehicle need to be updated;
obtain a new program version for updating the software and the firmware of the unmanned vehicle based on the specific field type; and
update the software and the firmware of the unmanned vehicle according to the new program version.

13. An unmanned vehicle software and firmware updating system, comprising an update server, an unmanned vehicle management system, and at least one of the unmanned vehicles, wherein
the update server is configured to release a new program version;
the unmanned vehicle management system is configured to send a new program update command in response to the new program version released by the update server; and
each of the unmanned vehicles comprises a positioning circuit and a processor, wherein
the positioning circuit provides a geographical location; and
the processor, coupled to the positioning circuit, is configured to:
receive the new program update command, and in response to the new program update command, enable the unmanned vehicle to perform an update program to obtain the geographical location of the unmanned vehicle;
obtain a specific field type corresponding to the geographical location;
obtain the new program version for updating a software and a firmware of the unmanned vehicle from the update server based on the specific field type; and
update the software and the firmware of the unmanned vehicle according to the new program version.

14. An unmanned vehicle software and firmware updating system, comprising an update server and at least one unmanned vehicle, wherein
the update server is configured to provide a new program version; and
each of the unmanned vehicles comprises a positioning circuit and a processor, wherein
the positioning circuit provides a geographical location; and
the processor, coupled to the positioning circuit, is configured to:
obtain the geographical location of the unmanned vehicle;
obtain a specific field type corresponding to the geographical location;
read a current specific field type of a program version of a software and a firmware of the unmanned vehicle;
determine that the software and the firmware of the unmanned vehicle need to be updated in response to the current specific field type being different from the specific field type;
obtain the new program version for updating the software and the firmware of the unmanned vehicle from the update server based on the specific field type in response to the software and the firmware of the unmanned vehicle being in need of updating; and
update the software and the firmware of the unmanned vehicle according to the new program version.
